(19) United States
(12) Patent Application Publication
(10) Pub. No.: US 2026/0339051 A1
(43) Pub. Date: Oct. 29, 2026

(54) ASSEMBLIES AND METHODS FOR COOLING AND HEATING COMPONENTS IN AN OUTDOOR CONDUCTION COOLED CLAMSHELL NETWORK SYSTEM

(71) Applicant: Ciena Corporation, Hanover, MD (US)

(72) Inventors: Ranjeet Chaurasiya, Gurugram (IN); Rampratap Mahawar, Gurugram (IN); Shubham Kumar, Gurugram (IN); Chander Prakash Gupta, Gurugram (IN); Suyash Agrawal, Gurugram (IN); Mukul Tripathi, Varanasi (IN)

(21) Appl. No.: 19/232,953

(22) Filed: Jun. 10, 2025

(30) Foreign Application Priority Data
Apr. 28, 2025 (IN) 202541040909

(51) Int. Cl. G02B 6/42

(52) U.S. Cl. CPC G02B 6/4268

(57) ABSTRACT

A thermal management assembly including a cage adapted to receive a pluggable optical module, an evaporator plate disposed adjacent to and in thermal communication with one side of the cage and the pluggable optical module when received in the cage, a condenser plate disposed adjacent to an opposite side of the cage and the pluggable optical module when received in the cage, where the condenser plate is adapted to be disposed adjacent to and in thermal communication with an inside surface of a base or a lid of a clamshell chassis, and one or more heat pipes disposed between and thermally coupling the evaporator plate to the condenser plate around the cage, thereby forming a thermal transfer path between the evaporator plate and the condenser plate. A passive energy transformation, transportation, and regeneration assembly is also provided for use in a clamshell chassis.

### CROSS-REFERENCE TO RELATED APPLICATION

The present disclosure claims the benefit of priority of co-pending Indian Patent Application No. 202541040909, filed on April 28, 2025, and entitled “ASSEMBLIES AND METHODS FOR COOLING AND HEATING COMPONENTS IN AN OUTDOOR CONDUCTION COOLED CLAMSHELL NETWORK SYSTEM,” the contents of which are incorporated in full by reference.

### TECHNICAL FIELD

The present disclosure relates generally to the telecommunications and networking fields. More particularly, the present disclosure relates to thermal management assemblies and methods for cooling and heating components in an outdoor conduction cooled clamshell network system.

### BACKGROUND

Some outdoor conduction cooled (fan-less) clamshell network systems and the like now incorporate 100G/200G/400G/800G coherent optics to cater to emerging network bandwidth requirements. Some such 25W coherent optics are required to work over an ambient temperature range of -40 to +60 degrees C, for example. This requires enhanced cooling and heating assemblies and methods, which do not currently exist.

As described in greater detail below, one conventional approach is to thermally couple an optics cage disposed facing upwards within a clamshell chassis to the lid of the clamshell chassis using a heatsink block attached to the lid of the clamshell chassis and thermal gaskets attached to the heatsink block or optics cage. This configuration allows the lid of the clamshell chassis to be opened and closed, but only works for low power optics (5W or less) or 100G optics that consume 5W of power or less. The long thermal resistance path provided through the heatsink block does not work for 25W coherent plugs or the like, and the configuration does not work when the lid of the clamshell chassis is open at all.

As also described in greater detail below, another conventional approach is to turn the optics cage and coherent plug upside down and thermally couple these components to the base of the clamshell chassis, providing a shorter thermal transfer path that is intact even when the lid of the clamshell chassis is open. This configuration, however, is inconvenient as inadequate visibility of and access to the optical fiber locking clip is provided, resulting in increased installation time and decreased installation efficiency.

Further, many outdoor conduction cooled (fan-less) clamshell network systems and the like now utilize multiple redundant power supply units (PSUs) disposed within the lid of the clamshell chassis, while the remaining electronic components are disposed within the base of the clamshell chassis, especially as power consumption increases with increased demand for high end processors, optical plugs, switch application specific integrated circuits (ASICs), and the like. Thus, for a 200W system, approximately 10% (or 20W) of the power is associated with the PSUs, while approximately 90% (or 180W) of the power is associated with the remaining electronic components. The result is a thermal imbalance, with the lid being cooler than the base, as well as a cooling/heating imbalance, in addition to existing design restrictions. This problem is not adequately addressed at present.

It will be readily apparent to those of ordinary skill in the art that the present background is provided as illustrative environmental context only and should not be construed to be limiting in any manner. The principles and concepts of the present disclose may be implemented in other environmental contexts equally, without limitation.

### BRIEF SUMMARY

The present disclosure provides a clamshell assembly or chassis incorporating a thermal management assembly that allows an optics cage and received pluggable optical module (POM) to be disposed adjacent to a closest inside surface of the clamshell chassis, such as the inside surface of a base (or lid) of the clamshell chassis, in an upwards facing orientation, while still providing a thermal transfer path from the top of the cage and POM to the inside surface of the base (or lid) and the associated heatsink fins. This solution eliminates the need for a long thermal transfer path through a heatsink block and/or the like to a remote inside surface of the clamshell chassis, while maintaining visibility of and access to a connector of a optical fiber of the plug. The solution works effectively in both cooling and heating modes, depending on the ambient temperature.

The present disclosure also provides a passive energy transformation, transportation, and regeneration (PETTR) assembly that utilizes one element in a higher-temperature area of the clamshell assembly to generate current from a injected heat (i.e., a heat differential). This current is then transported to a lower-temperature area of the clamshell assembly and converted back to heat via a second element. In this manner, heat is transferred from the higher-temperature area to the lower-temperature area, balancing the heat rejection load between the associated heatsink fins.

In some embodiments, the present disclosure provides a thermal management assembly including a cage adapted to receive a pluggable optical module, an evaporator plate disposed adjacent to and in thermal communication with one side of the cage and the pluggable optical module when received in the cage, a condenser plate disposed adjacent to an opposite side of the cage and the pluggable optical module when received in the cage, where the condenser plate is adapted to be disposed adjacent to and in thermal communication with an inside surface of a base or a lid of a clamshell chassis in which the thermal management assembly is disposed, and one or more heat pipes disposed between and thermally coupling the evaporator plate to the condenser plate around the cage, thereby forming a thermal transfer path between the evaporator plate and the condenser plate. In some embodiments, the evaporator plate is secured to the cage via one or more locking clips. In some embodiments, the thermal management assembly further includes a heater thermally coupled to the evaporator plate. The cage is secured to a printed circuit board adapted to be disposed within the clamshell chassis. In some embodiments, the printed circuit board defines a conformal cutout that accommodates the condenser plate and the one or more heat pipes. In some embodiments, the condenser plate is adapted to be disposed adjacent to and in thermal communication with the inside surface of the base or the lid of the clamshell chassis through an intervening thermal pad. The one side of the cage corresponding to a top surface of the pluggable optical module and the evaporator plate is remote from the inside surface of the base or the lid of the clamshell chassis relative to the opposite side of the cage corresponding to a bottom surface of the pluggable optical module and the condenser plate, such that a connector of an optical fiber coupled to the pluggable optical module is oriented such that the connector is accessible without obstruction from the base or the lid of the clamshell chassis when the clamshell chassis is in an open configuration with the lid separated from the base.

In some embodiments, the present disclosure provides a clamshell assembly including a clamshell chassis including a base and a lid, a cage disposed within the clamshell chassis and adapted to receive a pluggable optical module, an evaporator plate disposed adjacent to and in thermal communication with one side of the cage and the pluggable optical module when received in the cage, a condenser plate disposed adjacent to an opposite side of the cage and the pluggable optical module when received in the cage, where the condenser plate is adapted to be disposed adjacent to and in thermal communication with an inside surface of the base or the lid, and one or more heat pipes disposed between and thermally coupling the evaporator plate to the condenser plate around the cage, thereby forming a thermal transfer path between the evaporator plate and the condenser plate. In some embodiments, the evaporator plate is secured to the cage via one or more locking clips. In some embodiments, the clamshell assembly further includes a heater thermally coupled to the evaporator plate. The clamshell assembly further includes a printed circuit board disposed within the clamshell chassis and the cage is secured to the printed circuit board. In some embodiments, the printed circuit board defines a conformal cutout that accommodates the condenser plate and the one or more heat pipes. In some embodiments, the condenser plate is adapted to be disposed adjacent to and in thermal communication with the inside surface of the base or the lid of the clamshell chassis through an intervening thermal pad. The one side of the cage corresponding to a top surface of the pluggable optical module and the evaporator plate is remote from the inside surface of the base or the lid relative to the opposite side of the cage corresponding to a bottom surface of the pluggable optical module and the condenser plate, such that a connector of an optical fiber coupled to the pluggable optical module is oriented such that the connector is accessible without obstruction from the base or the lid when the clamshell chassis is in an open configuration with the lid separated from the base. The condenser plate is adapted to be disposed adjacent to and in thermal communication with the inside surface of the base or the lid when the clamshell chassis is in a closed configuration with the lid engaged with the base and when the clamshell chassis is in an open configuration with the lid separated from the base.

In some embodiments, the present disclosure provides a clamshell assembly including a clamshell chassis including a base and a lid, a thermoelectric generator disposed adjacent and thermally coupled to one of the base and the lid, and an electric resistor thermally disposed adjacent and thermally coupled to another of the base and the lid, where the thermoelectric generator is operable for generating a current using a temperature differential between the one of the base and the lid and an internal environment within the clamshell chassis, and where the electric resistor is operable for regenerating heat at the another of the base and the lid using the current. The clamshell assembly further includes a wire or trace coupling the thermoelectric generator to the electric resistor, where the wire or trace is operable for transporting the current from the thermoelectric generator to the electric resistor. The wire or trace is disposed at least partially through a protective cable support disposed between the base and the lid, allowing the clamshell chassis to be opened without damaging the wire or trace. In some embodiments, the thermoelectric generator is disposed adjacent and thermally coupled to a hot plate of the one of the base and the lid. The hot plate is disposed adjacent to and in thermal communication with one or more hot components disposed in the one of the base and the lid. In some embodiments, the thermoelectric generator includes one or more protrusions that are thermally coupled to the internal environment within the clamshell chassis. In some embodiments, the base includes a plurality of heatsink fins and the lid includes a plurality of heatsink fins, and the thermoelectric generator and the thermoelectric resistor serve to balance heat rejection by the plurality of heatsink fins of the base and the plurality of heatsink fins of the lid.

It will be readily apparent to those of ordinary skill in the art that aspects and features of the described embodiments may be included, omitted, or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate.

FIG. 1 illustrates one conventional approach for thermally coupling an optics cage disposed facing upwards within a clamshell chassis to the lid of the clamshell chassis using a heatsink block attached to the lid of the clamshell chassis and thermal gaskets attached to the heatsink block or optics cage, with the clamshell chassis in a closed configuration.

FIG. 2 also illustrates one conventional approach for thermally coupling an optics cage disposed facing upwards within a clamshell chassis to the lid of the clamshell chassis using a heatsink block attached to the lid of the clamshell chassis and thermal gaskets attached to the heatsink block or optics cage, with the clamshell chassis in an open configuration.

FIG. 3 illustrates another conventional approach involving turning the optics cage and coherent plug upside down and thermally coupling these components to the base of the clamshell chassis, providing a shorter thermal transfer path that is intact even when the lid of the clamshell chassis is open.

FIG. 4 illustrates an embodiment of thermal management assembly of the present disclosure, utilizing a condenser plate, an evaporator plate, and one or more adjoining heat pipes disposed around a cage and a received POM, providing a short thermal transfer path from the cage and POM to a nearest inside wall of the associated clamshell chassis.

FIG. 5 also illustrates an embodiment of thermal management assembly of the present disclosure, utilizing the condenser plate, the evaporator plate, and the one or more adjoining heat pipes disposed around the cage and the received POM, providing the short thermal transfer path from the cage and POM to the nearest inside wall of the associated clamshell chassis.

FIG. 6 further illustrates an embodiment of thermal management assembly of the present disclosure, utilizing the condenser plate, the evaporator plate, and the one or more adjoining heat pipes disposed around the cage and the received POM, providing the short thermal transfer path from the cage and POM to the nearest inside wall of the associated clamshell chassis.

FIG. 7 still further illustrates an embodiment of thermal management assembly of the present disclosure, utilizing the condenser plate, the evaporator plate, and the one or more adjoining heat pipes disposed around the cage and the received POM, providing the short thermal transfer path from the cage and POM to the nearest inside wall of the associated clamshell chassis.

FIG. 8 illustrates an embodiment of the thermal management assembly of the present disclosure being assembled to/through an associated printed circuit board (PCB) within an associated clamshell chassis.

FIG. 9 still further illustrates an embodiment of thermal management assembly of the present disclosure, utilizing the condenser plate, the evaporator plate, and the one or more adjoining heat pipes disposed around the cage and the received POM, providing the short thermal transfer path from the cage and POM to the nearest inside wall of the associated clamshell chassis.

FIG. 10 illustrates a conventional clamshell assembly configuration, in which a temperature disparity may exist between the base and associated heatsink fins and the lid and associated heatsink fins due to the placement of hot components within the clamshell chassis.

FIG. 11 illustrates an embodiment of the PETTR assembly of the present disclosure.

FIG. 12 illustrates an embodiment of the PETTR assembly of the present disclosure installed in the clamshell assembly of the present disclosure.

FIG. 13 illustrates an operating principle of the PETTR assembly of the present disclosure.

FIG. 14 illustrates another operating principle of the PETTR assembly of the present disclosure.

It will be readily apparent to those of ordinary skill in the art that aspects and features of the illustrated embodiments may be included, omitted, or combined as desired in a given application, without limitation.

### DETAILED DESCRIPTION

Again, some outdoor conduction cooled (fan-less) clamshell network systems and the like now incorporate 100G/200G/400G/800G coherent optics to cater to emerging network bandwidth requirements. Some such 25W coherent optics are required to work over an ambient temperature range of -40 to +60 degrees C, for example. This requires enhanced cooling and heating assemblies and methods, which do not currently exist.

As mentioned above, one conventional approach is to thermally couple an optics cage disposed facing upwards within a clamshell chassis to the lid of the clamshell chassis using a heatsink block attached to the lid of the clamshell chassis and thermal gaskets attached to the heatsink block or optics cage. This configuration allows the lid of the clamshell chassis to be opened and closed, but only works for low power optics (5W or less) or 100G optics that consume 5W of power or less. The long thermal resistance path provided through the heatsink block does not work for 25W coherent plugs or the like, and the configuration does not work when the lid of the clamshell chassis is open at all.

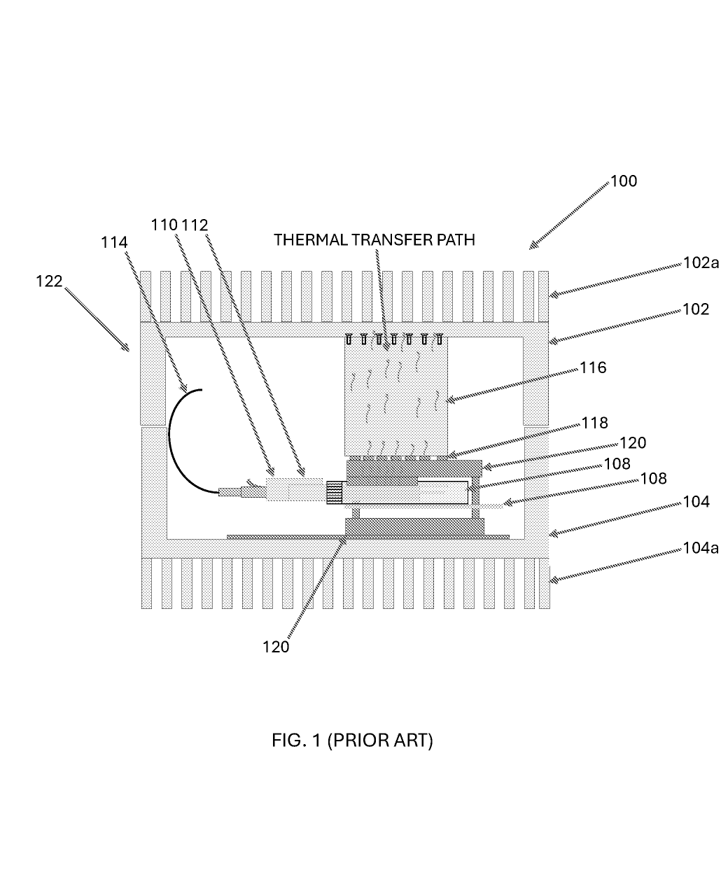

Referring to FIG. 1, the clamshell assembly or chassis 100 includes a lid 102 and a base 104 that are selectively coupled together (pivotably, translatably, or the like) to form a sealed housing. The lid 102 may include a heatsink (fins, protrusions, or the like) 102a adapted to communicate heat between the lid 102 and the external environment. Similarly, the base 104 may include a heatsink (fins, protrusions, or the like) 104a adapted to communicate heat between the base 104 and the external environment. A PCB 106 is disposed within the base 104, and a cage 108 is disposed facing upwards on the PCB 106. It will be readily apparent to those of ordinary skill in the art that the lid 102 and the base 104 can be swapped in all embodiments. The cage 108 is adapted to receive a POM 110 including coherent optics 112 or the like that generate heat and must be cooled in hot ambient conditions and heated in cold ambient conditions to operate properly. The POM 110 is a plug that is adapted to receive one or more optical fibers 114. The cage 108 and POM 110 are thermally coupled to the lid 102 through a heatsink block 116 that is attached to the inside of the lid 102, as well as one or more thermal gaskets 118 that are attached to the heatsink block 116 and thermally contact the cage 108 when the lid 102 is closed. Alternatively, the one or more thermal gaskets 118 are attached to the cage 108 and thermally contact the heatsink block 116 when the lid 102 is closed. The thermal gaskets 118 may be graphite over foam (GoF) thermal gaskets or the like. One or more intervening heatsink blocks, vapor chambers (VCs), thermoelectric coolers (TECs), or the like 120 may also be disposed between the cage 108 and POM 110 and the thermal gaskets 118, as well as between the cage 108, POM 110, and/or PCB 106 and the base 104.

In this arrangement, a long heat transfer path is provided between the cage 108 and POM 110 and the lid 102, through the thermal gaskets 118 and the heatsink block 116, when the lid 102 is closed. This results in a high thermal resistance between the cage 108 and the POM 110 and the lid 102, which is acceptable for low power (5W or lower) optics, but not acceptable for high power (25W or higher) optics. The thermal gaskets 118 exacerbate this problem, but are required as a sliding or moving interface is provided at this juncture due to the opening a closing of the lid 102. The juncture must provide a corresponding tolerance and accommodate such movement.

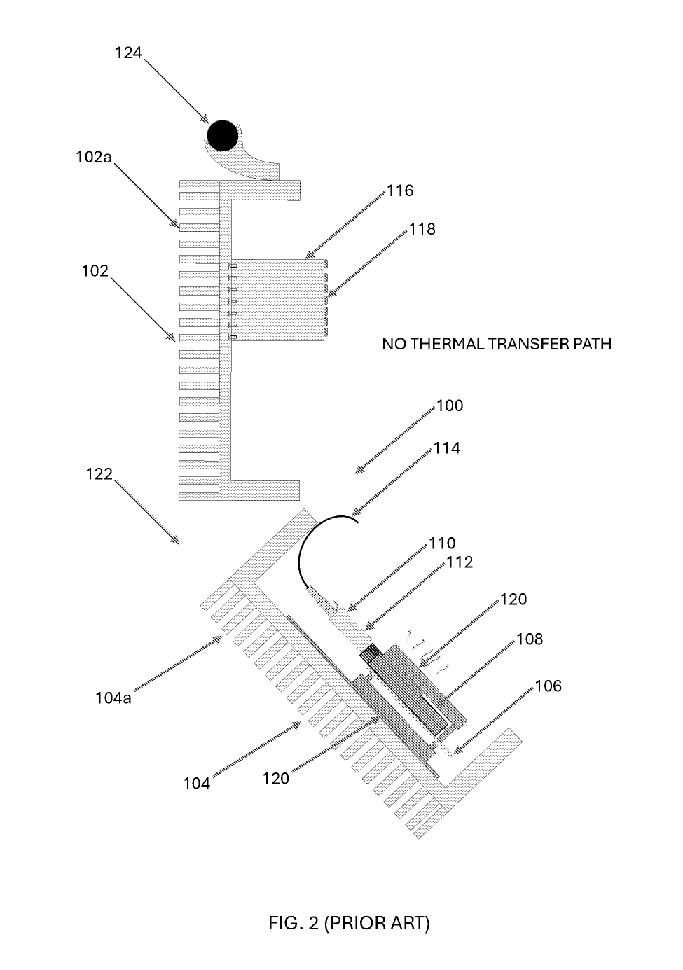

As illustrated in FIG. 2, when the lid 102 or base 104 of the clamshell chassis 100 is opened, such as during lab testing or field servicing of the clamshell assembly components, no thermal transfer path is provided between the cage 108 and POM 110 and the lid 102 through the heatsink block and the thermal gaskets 118. In such cases, the coherent optics 112 are not cooled and may be damaged, with field traffic being disrupted. As illustrated, the lid 102 is retained in the clamshell network system 122 via a thread mount or the like 124.

As also mentioned above, another conventional approach is to turn the optics cage and coherent plug (QSFPDD, OSFP, or the like) upside down and thermally couple these components to the base of the clamshell chassis, providing a shorter thermal transfer path that is intact even when the lid of the clamshell chassis is open. This configuration, however, is inconvenient as inadequate visibility of and access to the optical fiber locking clip is provided, resulting in increased installation time and decreased installation efficiency.

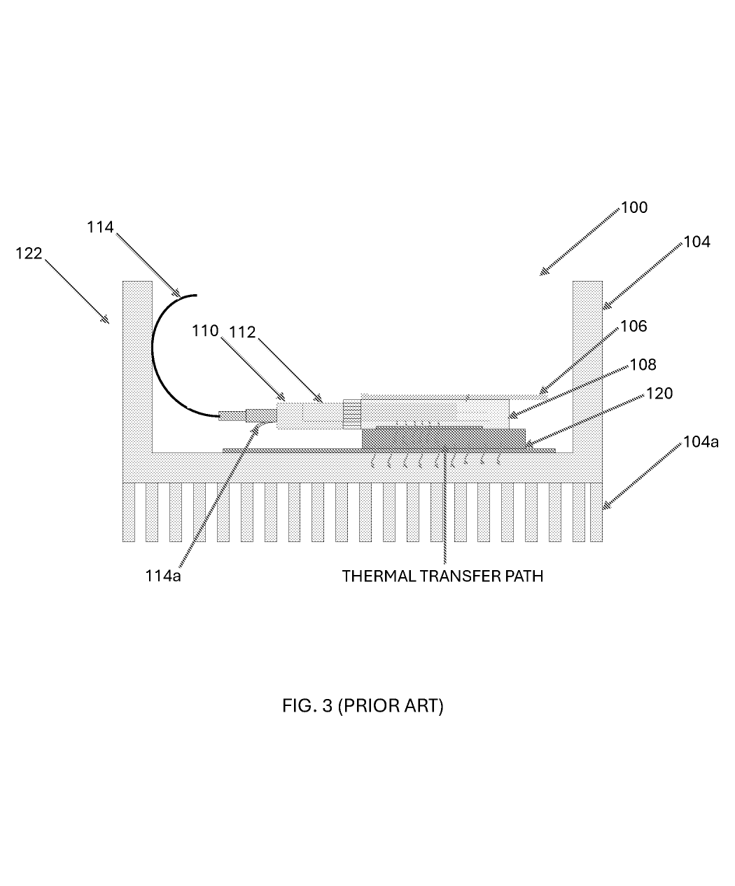

Referring to FIG. 3, the cage 108 and received POM 110 are coupled to the PCB 106 upside down within the base 104 (or the lid 102) of the clamshell chassis 100. This provides a short thermal transfer path with minimal thermal resistance from the cage 108 and POM 110 to the base 104 and associated heatsink fins 104a, through any intervening thermal gasket, heatsink block, VC, and/or TEC 120. However, in this arrangement, it is difficult to visualize and access the connector 114a of the optical fiber 114 due to the close proximity of the cage 108 and POM 110 to the inside of the base 104. This problem is exacerbated when a tester or installer is wearing bulky gloves and when a thread mounted clamshell assembly 100 is open an oscillates in the field due to wind or the like. This increases testing and installation time, decreases testing an installation efficiency, etc. It is thus preferable that the cage 108 and POM 110 remain facing upwards to avoid improper/inadequate/damaged connections and the like.

The clamshell assembly or chassis 100 of the present disclosure improves on the above thermal management solutions, allowing the cage 108 and received POM 110 to be disposed adjacent to a closest inside surface of the clamshell chassis 100, such as the inside surface of the base 104, in an upwards facing orientation, while still providing a thermal transfer path from the top of the cage 108 and POM 110 to the inside surface of the base 104 and the associated heatsink fins 104a. This solution eliminates the need for a long thermal transfer path through the heatsink block 116, while maintaining visibility of and access to the connector 114a of the optical fiber 114.

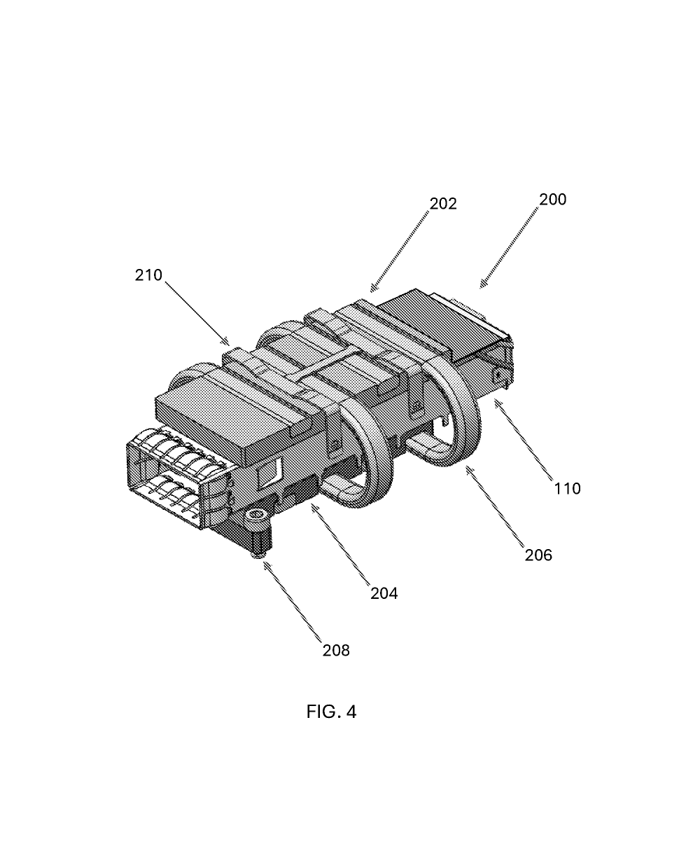

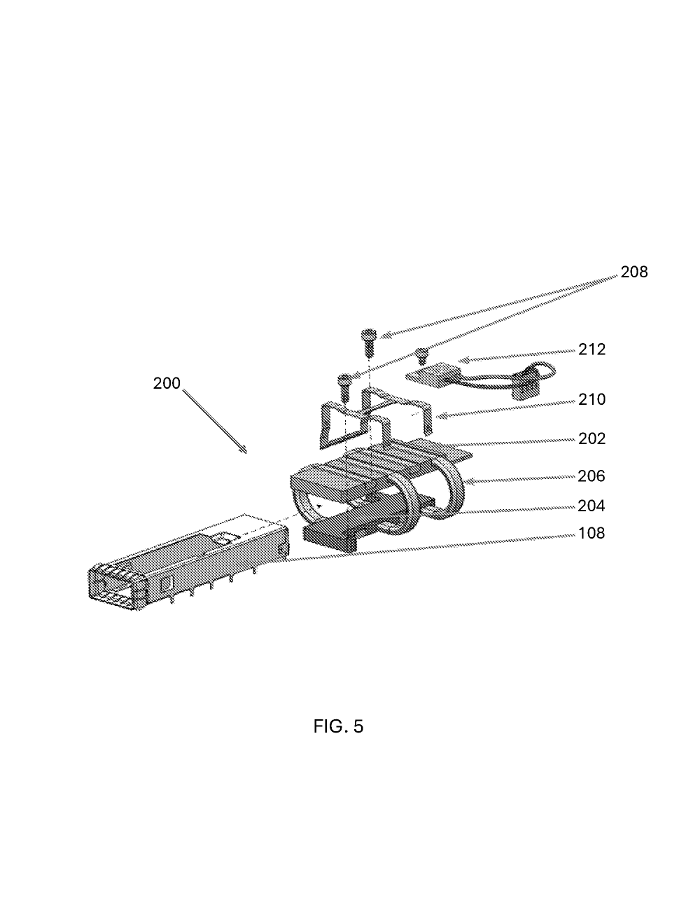

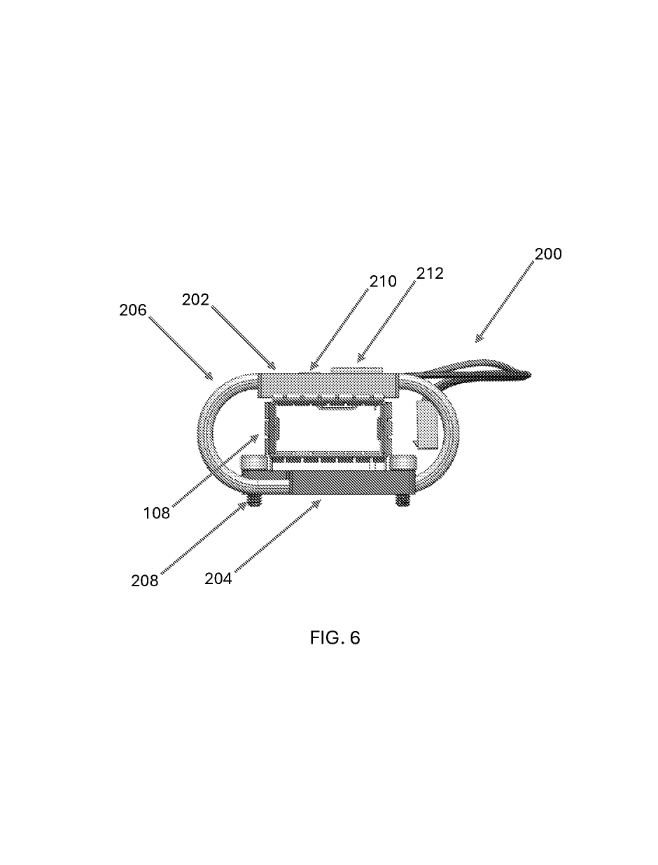

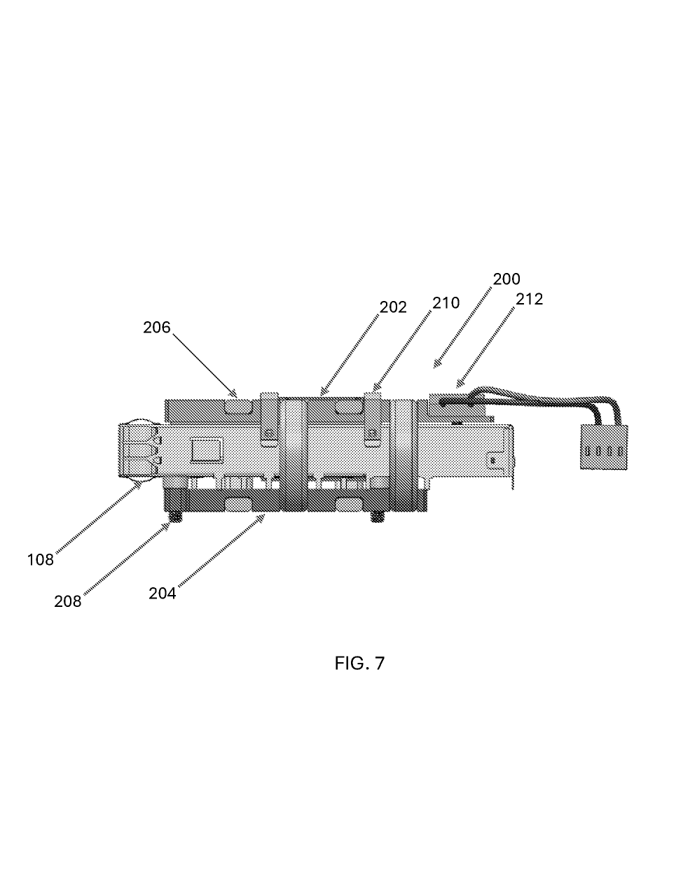

Referring to FIGS. 4-7, the thermal management assembly 200 of the present disclosure includes a cage 108 that is adapted to receive a POM 110 in an upwards facing configuration, adjacent to a proximate inside surface of the base 104 of the associated clamshell chassis 100. It should be noted that, if the proximate inside surface of the clamshell chassis 100 is the lid 102, then the cage 108 and POM are in an upside down configuration when the clamshell chassis 100 is closed, but in an upwards facing configuration when the clamshell chassis 100 is open. In either case, the thermal transfer path between the cage 108 and POM 100 are minimized, and visibility of and access to a connector 114a of an optical fiber 114 of the plug are provided, as the base 104 or the lid 102 do not act as interfering space constraints.

An evaporator plate 202 is disposed adjacent to and in thermal contact with a top surface of the cage 108 and the POM 110, while a condenser plate 204 is disposed adjacent to a bottom surface of the cage 108 and POM 110 and is in thermal communication with an inside surface of the base 104 (or lid 102) of the clamshell chassis 100, as well as the associated heatsink fins 104a (or heatsink fins 102a). The evaporator plate 202 is thermally coupled to the condenser plate 204 via one or more heat pipes 206 disposed conformally around the cage 108 and POM 110. The evaporator plate 202 works via internal fluid evaporation and includes an embedded pedestal that receives heat from the optics of the POM 110. The condenser plate 204 works via internal fluid condensation and is fixed to the base 104 via a plurality of screws or other fasteners 208 such that the condenser plate is in thermal communication with the base 104 and heatsink fins 104a. The heat pipes 208 are coupled to and embedded in both the evaporator plate 202 and the condenser plate 204 and surround the cage 108 and the high power optics (25W or greater) of the POM 110. The heat pipes 206 have high thermal conduction at high ambient temperatures and effectively transfer heat from the evaporator plate 202 to the condenser plate 204, and thus from the high power optics of the POM 110 to the heatsink fins 104aand the ambient environment via an evaporation-capillary action-condensation cycle. The fluid is heated and evaporates in the evaporator plate 202, steam travels through the heat pipes 206, and the steam rejects heat to the heatsink fins 104a and ambient environment and is condensed back to the fluid in the condenser plate 204. The fluid is then transferred from the condenser plate 204 back to the evaporator plate 202 via capillary action through the heat pipes 206, such that the cycle may be repeated.

The evaporator plate 202, condenser plate 204, and heat pipes 206 may be secured to the cage 108 using one or more locking clips or other fasteners 210. Further, a heater 212 may be thermally coupled to the evaporator plate 202 to heat the POM 110 under cold ambient conditions (less than 0 degrees C). This heating is enhanced by the fact that, under such cold ambient conditions, the fluid in the heat pipes 206 freezes, such that the thermal conductivity of the heat pipes 206 is minimal. This thermally isolates the POM 110, evaporator plate 202, and heater 212, such that the heater 212 more effectively heats the POM 110 through the embedded pedestal of the evaporator plate 202.

The thermal management assembly 200 is assembled by first joining the evaporate plate 202 to the condenser plate 204 by soldering the heat pipes 206 between the evaporator plate 202 and the condenser plate 204. The cage 108 is then inserted into this assembly and the evaporator plate 202 is secured to the cage 108 using the locking clips 210. The heater 212 may be thermally coupled to the evaporator plate 202 before or after this securement process.

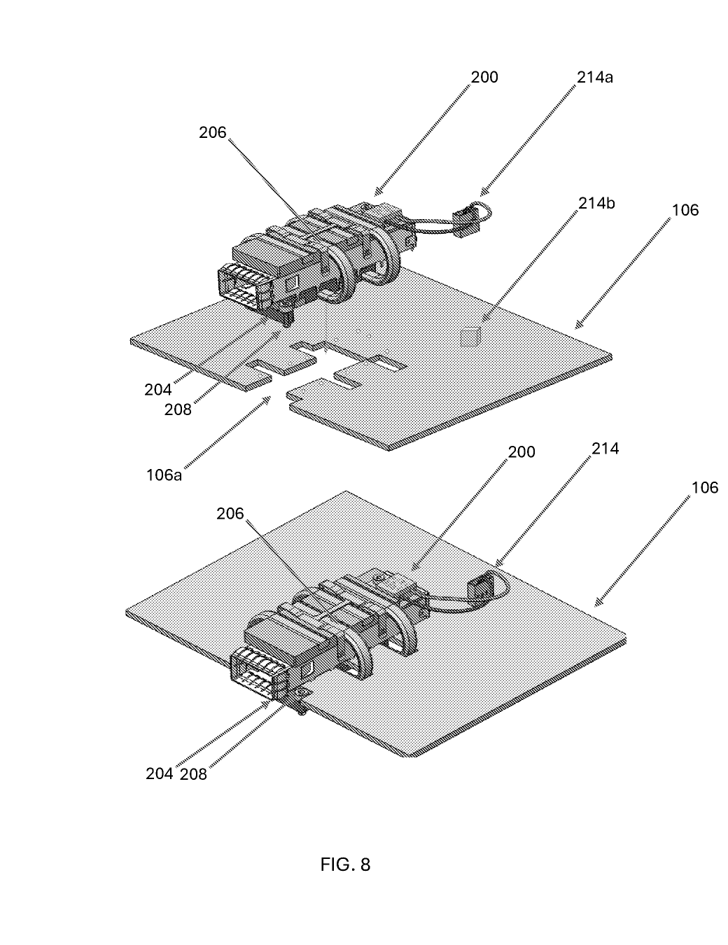

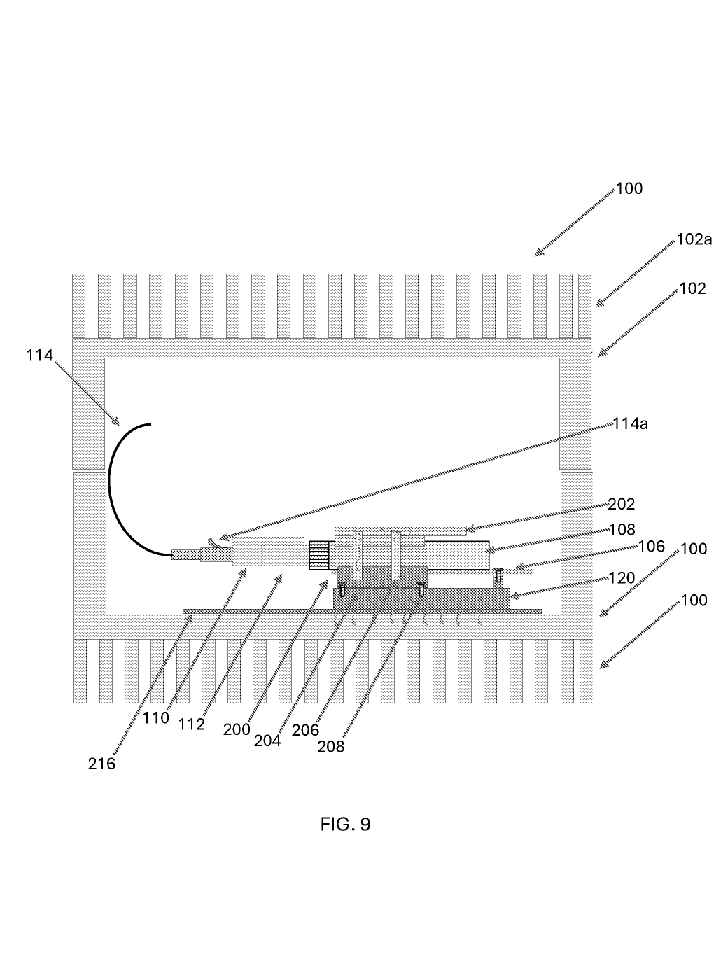

Referring to FIGS. 8 and 9, the thermal management assembly 200 is press-fitted into a conformal cutout 106a of the PCB 106 that is disposed within the clamshell chassis 100. This conformal cutout 106a accommodates the condenser plate 204 and the heat pipes 206, as well as the screws 208 used to affix the thermal management assembly 200 to the base 104 of the clamshell chassis 100. The PCB 106 is disposed adjacent to the base 104 of the clamshell chassis 100, optionally with a thermal pad 216 disposed between the condenser plate 204 and the base 104. An electrical connector 214a of the heater 212 is connected to an electrical connector 214b of the PCB 106 to form an electrical connection 214 for the heater 212.

Referring to FIG. 9, again, the thermal management assembly 200 of the present disclosure includes the cage 108 that is adapted to receive the POM 110 in an upwards facing configuration, adjacent to the proximate inside surface of the base 104 of the associated clamshell chassis 100. It should again be noted that, if the proximate inside surface of the clamshell chassis 100 is the lid 102, then the cage 108 and POM are in an upside down configuration when the clamshell chassis 100 is closed, but in an upwards facing configuration when the clamshell chassis 100 is open. In either case, the thermal transfer path between the cage 108 and POM 100 are minimized, and visibility of and access to the connector 114a of the optical fiber 114 of the plug are provided, as the base 104 or the lid 102 do not act as interfering space constraints. A shortest thermally resistive path is provided between the POM 110 and the inside surface of the base 104, whether the lid 102 of the clamshell chassis 100 is opened or closed. Optionally, this resistive path is provided through an intervening VC or relatively thin heatsink block 120 and/or the thermal pad 216. Further, the access provided helps ensure that the fiber 114 is not damaged when the optics are inserted or removed.

The evaporator plate 202 is disposed adjacent to and in thermal contact with the top surface of the cage 108 and the POM 110, while the condenser plate 204 is disposed adjacent to the bottom surface of the cage 108 and POM 110 and is in thermal communication with the inside surface of the base 104 (or lid 102) of the clamshell chassis 100, as well as the associated heatsink fins 104a (or heatsink fins 102a). The evaporator plate 202 is thermally coupled to the condenser plate 204 via the one or more heat pipes 206 disposed conformally around the cage 108 and POM 110. The evaporator plate 202 again works via internal fluid evaporation and includes the embedded pedestal that receives heat from the optics of the POM 110. The condenser plate 204 works via internal fluid condensation and is fixed to the base 104 via the plurality of screws or other fasteners 208 such that the condenser plate is in thermal communication with the base 104 and heatsink fins 104a. The heat pipes 208 are coupled to and embedded in both the evaporator plate 202 and the condenser plate 204 and surround the cage 108 and the high power optics (25W or greater) of the POM 110. The heat pipes 206 have high thermal conduction at high ambient temperatures and effectively transfer heat from the evaporator plate 202 to the condenser plate 204, and thus from the high power optics of the POM 110 to the heatsink fins 104a and the ambient environment via an evaporation-capillary action-condensation cycle. The fluid is heated and evaporates in the evaporator plate 202, steam travels through the heat pipes 206, and the steam rejects heat to the heatsink fins 104a and ambient environment and is condensed back to the fluid in the condenser plate 204. The fluid is then transferred from the condenser plate 204 back to the evaporator plate 202 via capillary action through the heat pipes 206, such that the cycle may be repeated.

The evaporator plate 202, condenser plate 204, and heat pipes 206 may be secured to the cage 108 using the one or more locking clips or other fasteners 210. Further, the heater 212 may be thermally coupled to the evaporator plate 202 to heat the POM 110 under cold ambient conditions (less than 0 degrees C). This heating is enhanced by the fact that, under such cold ambient conditions, the fluid in the heat pipes 206 freezes, such that the thermal conductivity of the heat pipes 206 is minimal. This thermally isolates the POM 110, evaporator plate 202, and heater 212, such that the heater 212 more effectively heats the POM 110 through the embedded pedestal of the evaporator plate 202.

Again, many outdoor conduction cooled (fan-less) clamshell network systems and the like now utilize multiple redundant PSUs disposed within the lid of the clamshell chassis, while the remaining electronic components are disposed within the base of the clamshell chassis, especially as power consumption increases with increased demand for high end processors, optical plugs, switch ASICs, and the like. Thus, for a 200W system, approximately 10% (or 20W) of the power is associated with the PSUs, while approximately 90% (or 180W) of the power is associated with the remaining electronic components. The result is a thermal imbalance, with the lid being cooler than the base, as well as a cooling/heating imbalance, in addition to existing design restrictions. This problem is not adequately addressed at present.

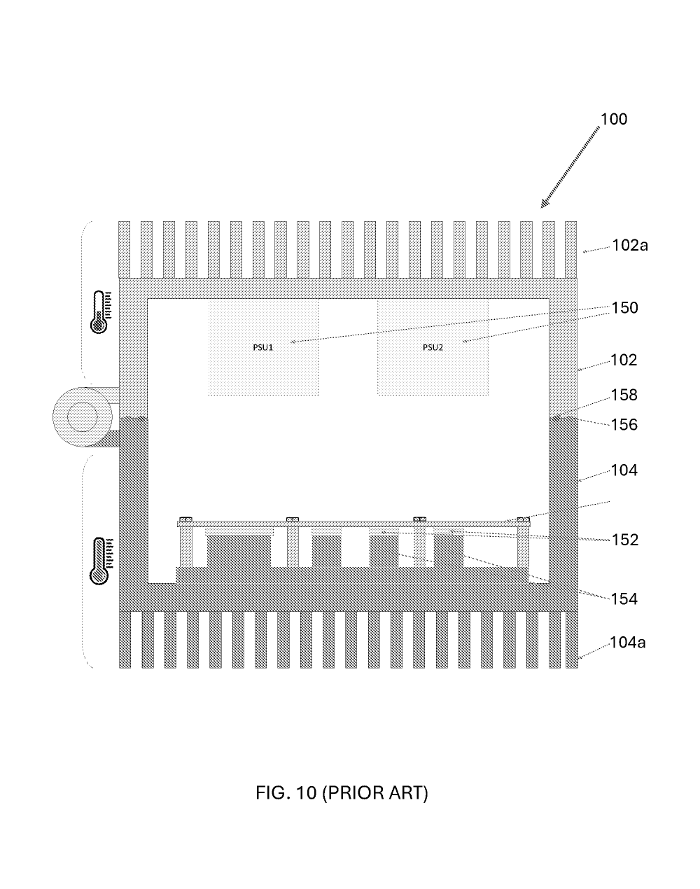

Referring to FIG. 10, two PSUs 150 are disposed within the lid 102 of the clamshell assembly or chassis 100 and cooled by the associated heatsink fins 102a, while the hot components 152 are coupled to the PCB 106 in the base 104 of the clamshell assembly or chassis 100. The hot components 152 may be thermally coupled to the base 104 and the associated heatsink fins 104a by one or more thermal heatsink protrusions 154 disposed between the hot components 152 and the base 104. A rubber gasket or the like 156 is provided for hermetically sealing the lid 102 to the base 104 when the clamshell chassis 100 is closed and a conductive gasket or the like 158 is provided for sealing the clamshell chassis 100 with respect to electromagnetic interference (EMI). Due to the arrangement of the components within the clamshell chassis 100, the base 104 will typically have a higher resulting temperature than the lid 102, with the heatsink fins 102a of the lid 102 rejecting less heat to the ambient environment and effectively being underutilized. The present disclosure addresses this power distribution and cooling imbalance.

The present disclosure provides a PETTR assembly that utilizes one element in a higher-temperature area of the clamshell assembly 100 to generate current from a injected heat (i.e., a heat differential). This current is then transported to a lower-temperature area of the clamshell assembly 100 and converted back to heat via a second element. In this manner, heat is transferred from the higher-temperature area to the lower-temperature area, balancing the heat rejection load between the associated heatsink fins.

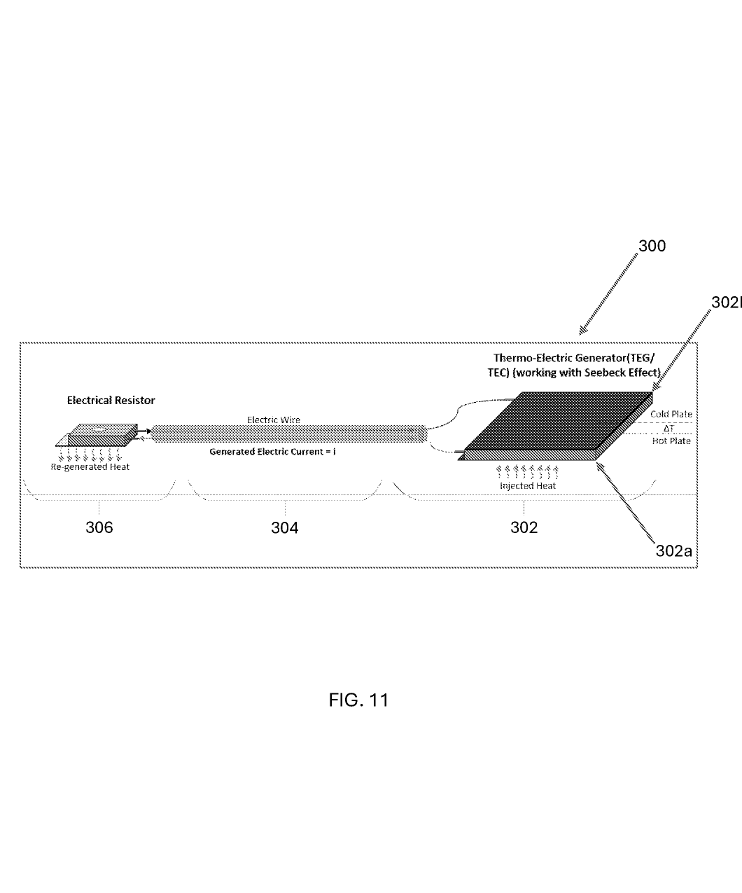

FIG. 11 illustrates an embodiment of the PETTR assembly 300 of the present disclosure. The PETTR assembly 300 includes a TEC that is operated as a thermoelectric generator (TEG) 302 using the Seebeck effect. A TEC typically converts electric power to heat to cool or heat a component using the Peltier effect. In an opposite manner, the TEG 302 uses the Seebeck effect, where a temperature differential across opposed surfaces (hot plate 302a and cold plate 302b) of the TEG 302 generate an electric current that may be transported via a wire or trace 304. This transported current is the converted to back to heat by a remote electrical resistor 306.

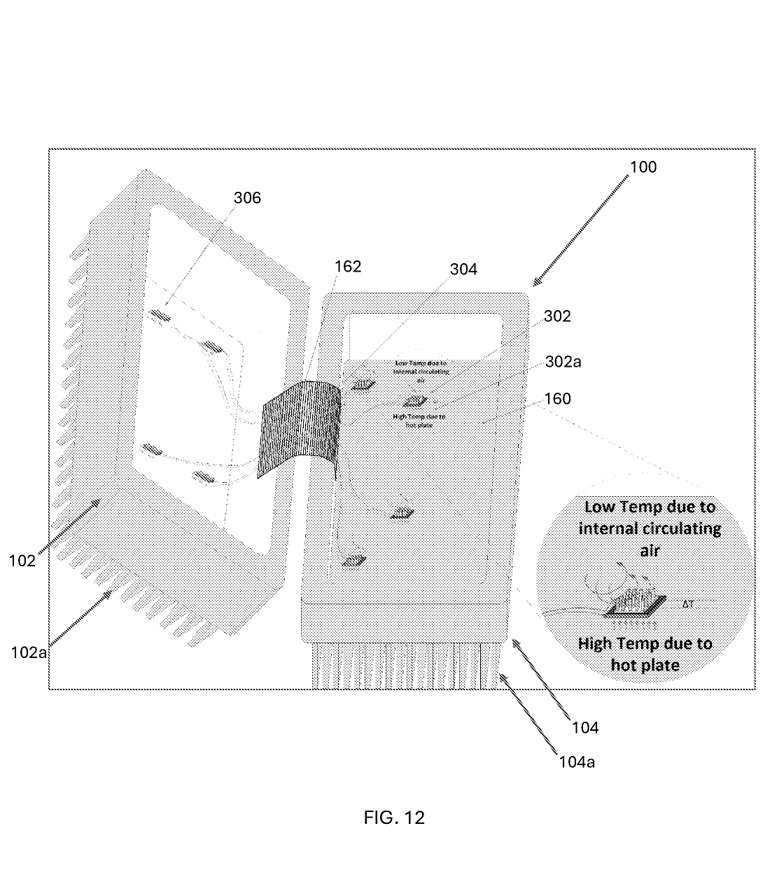

FIG. 12 illustrates an embodiment of the PETTR assembly 300 of the present disclosure installed in the clamshell assembly 100 of the present disclosure. One or more TEGs 302 are disposed on or adjacent to a hot surface 160 associated with the hot components 152 disposed within the base 104 (or lid 102) of the clamshell chassis 100. The one or more TEGs 302 are also exposed to a relatively cooler circulating airflow within the clamshell chassis 100. This creates the required temperature differential between the hot plate 302a and the cold plate 302b of each TEG 302. The resulting current(s) is/are transported through one or more wires or traces 304, which are routed through a protective cable support 162 between the base 104 and the lid 102. One or more corresponding electrical resistors 306 are disposed on or adjacent to a relatively cooler surface of the lid 102 (or base 104) of the clamshell chassis 100, where the current(s) is/are converted to regenerated heat. In this manner, heat is more effectively balanced between the base 104 and the associated heatsink fins 104a and the lid 102 and the associated heatsink fins 102a.

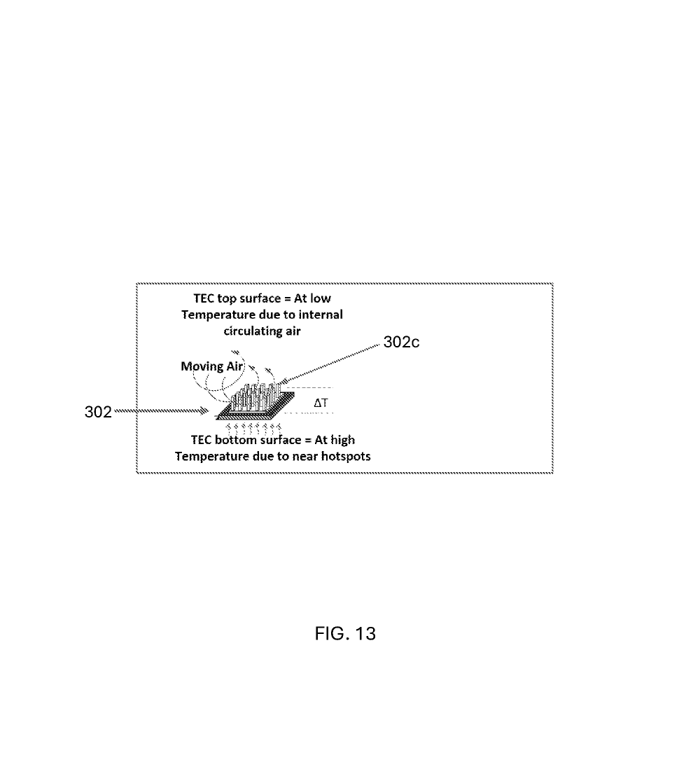

FIG. 13 illustrates an operating principle of the PETTR assembly 300 of the present disclosure, highlighting the temperature differential experienced at the hot plate 302a and a plurality of protrusions 302c coupled to the cold plate 302b of the TEG 302.

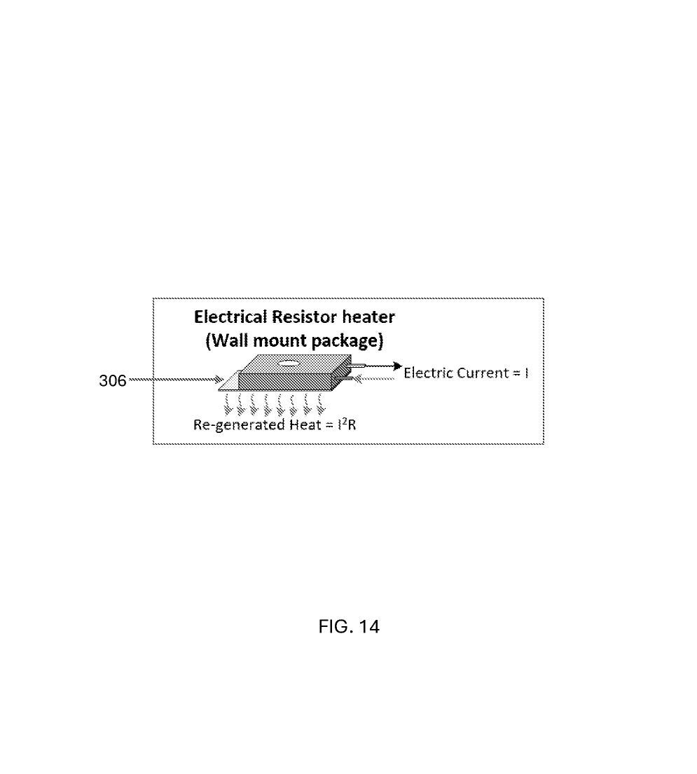

FIG. 14 illustrates another operating principle of the PETTR assembly 300 of the present disclosure, highlighting the current-to-heat regeneration provided by the electric resistor 306 at a wall of the clamshell chassis 100.

Although the present disclosure is illustrated and described with reference to specific embodiments and examples, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A thermal management assembly comprising
a cage adapted to receive a pluggable optical module,
an evaporator plate disposed adjacent to and in thermal communication with one side of the cage and the pluggable optical module when received in the cage,
a condenser plate disposed adjacent to an opposite side of the cage and the pluggable optical module when received in the cage, wherein the condenser plate is adapted to be disposed adjacent to and in thermal communication with an inside surface of a base or a lid of a clamshell chassis in which the thermal management assembly is disposed, and
one or more heat pipes disposed between and thermally coupling the evaporator plate to the condenser plate around the cage, thereby forming a thermal transfer path between the evaporator plate and the condenser plate.

2. The thermal management assembly of claim 1, wherein the evaporator plate is secured to the cage via one or more locking clips.

3. The thermal management assembly of claim 1, further comprising a heater thermally coupled to the evaporator plate.

4. The thermal management assembly of claim 1, wherein the cage is secured to a printed circuit board adapted to be disposed within the clamshell chassis, wherein the printed circuit board defines a conformal cutout that accommodates the condenser plate and the one or more heat pipes.

5. The thermal management assembly of claim 1, wherein the condenser plate is adapted to be disposed adjacent to and in thermal communication with the inside surface of the base or the lid of the clamshell chassis through an intervening thermal pad.

6. The thermal management assembly of claim 1, wherein the one side of the cage corresponding to a top surface of the pluggable optical module and the evaporator plate is remote from the inside surface of the base or the lid of the clamshell chassis relative to the opposite side of the cage corresponding to a bottom surface of the pluggable optical module and the condenser plate, such that a connector of an optical fiber coupled to the pluggable optical module is oriented such that the connector is accessible without obstruction from the base or the lid of the clamshell chassis when the clamshell chassis is in an open configuration with the lid separated from the base.

7. A clamshell assembly comprising
a clamshell chassis comprising a base and a lid,
a cage disposed within the clamshell chassis and adapted to receive a pluggable optical module,
an evaporator plate disposed adjacent to and in thermal communication with one side of the cage and the pluggable optical module when received in the cage,
a condenser plate disposed adjacent to an opposite side of the cage and the pluggable optical module when received in the cage, wherein the condenser plate is adapted to be disposed adjacent to and in thermal communication with an inside surface of the base or the lid, and
one or more heat pipes disposed between and thermally coupling the evaporator plate to the condenser plate around the cage, thereby forming a thermal transfer path between the evaporator plate and the condenser plate.

8. The clamshell assembly of claim 7, wherein the evaporator plate is secured to the cage via one or more locking clips.

9. The clamshell assembly of claim 7, further comprising a heater thermally coupled to the evaporator plate.

10. The clamshell assembly of claim 7, further comprising a printed circuit board disposed within the clamshell chassis, wherein the cage is secured to the printed circuit board, and wherein the printed circuit board defines a conformal cutout that accommodates the condenser plate and the one or more heat pipes.

11. The clamshell assembly of claim 7, wherein the condenser plate is adapted to be disposed adjacent to and in thermal communication with the inside surface of the base or the lid of the clamshell chassis through an intervening thermal pad.

12. The clamshell assembly of claim 7, wherein the one side of the cage corresponding to a top surface of the pluggable optical module and the evaporator plate is remote from the inside surface of the base or the lid relative to the opposite side of the cage corresponding to a bottom surface of the pluggable optical module and the condenser plate, such that a connector of an optical fiber coupled to the pluggable optical module is oriented such that the connector is accessible without obstruction from the base or the lid when the clamshell chassis is in an open configuration with the lid separated from the base.

13. The clamshell assembly of claim 7, wherein the condenser plate is adapted to be disposed adjacent to and in thermal communication with the inside surface of the base or the lid when the clamshell chassis is in a closed configuration with the lid engaged with the base and when the clamshell chassis is in an open configuration with the lid separated from the base.

14. The clamshell assembly of claim 7, further comprising:
a thermoelectric generator disposed adjacent and thermally coupled to one of the base and the lid, and
an electric resistor thermally disposed adjacent and thermally coupled to another of the base and the lid,
wherein the thermoelectric generator is operable for generating a current using a temperature differential between the one of the base and the lid and an internal environment within the clamshell chassis, and
wherein the electric resistor is operable for regenerating heat at the another of the base and the lid using the current.

15. A clamshell assembly comprising
a clamshell chassis comprising a base and a lid,
a thermoelectric generator disposed adjacent and thermally coupled to one of the base and the lid, and
an electric resistor thermally disposed adjacent and thermally coupled to another of the base and the lid,
wherein the thermoelectric generator is operable for generating a current using a temperature differential between the one of the base and the lid and an internal environment within the clamshell chassis, and
wherein the electric resistor is operable for regenerating heat at the another of the base and the lid using the current.

16. The clamshell assembly of claim 15, further comprising
a wire or trace coupling the thermoelectric generator to the electric resistor,
wherein the wire or trace is operable for transporting the current from the thermoelectric generator to the electric resistor.

17. The clamshell assembly of claim 16, wherein the wire or trace is disposed at least partially through a protective cable support disposed between the base and the lid, allowing the clamshell chassis to be opened without damaging the wire or trace.

18. The clamshell assembly of claim 15, wherein the thermoelectric generator is disposed adjacent and thermally coupled to a hot plate of the one of the base and the lid, and wherein the hot plate is disposed adjacent to and in thermal communication with one or more hot components disposed in the one of the base and the lid.

19. The clamshell assembly of claim 15, wherein the thermoelectric generator comprises one or more protrusions that are thermally coupled to the internal environment within the clamshell chassis.

20. The clamshell assembly of claim 15, wherein the base comprises a plurality of heatsink fins and the lid comprises a plurality of heatsink fins, and wherein the thermoelectric generator and the thermoelectric resistor serve to balance heat rejection by the plurality of heatsink fins of the base and the plurality of heatsink fins of the lid.
